(19) United States
(12) Patent Application Publication
(10) Pub. No.: US 2024/0317016 A1
(43) Pub. Date: Sep. 26, 2024

(54) MULTI-VALVE FLUID DISTRIBUTION SYSTEM

(71) Applicant: Dana Canada Corporation, Oakville (CN)

(72) Inventors: Michael MARTIN, Hamilton (CA); John BRUZEWSKI, Buchanan, TN (US)

(21) Appl. No.: 18/187,592

(22) Filed: Mar. 21, 2023

(51) Int. Cl. B60H 1/00

(52) U.S. Cl. CPC B60H 1/00485; B60H 1/00278; B60H 1/00885

(57) ABSTRACT

Systems are provided for a fluid distribution system of for reconfigurable thermal management. In one example, a fluid distribution system comprises a fluid manifold that includes a plurality of sections with a plurality of inlet and outlet ports, and a pilot assembly including a plurality of manifold sections, a plurality of selectively couplable fluid chambers, and a plurality of solenoid-actuated pilot valve assemblies. The plurality of solenoid-actuated pilot valve assemblies control fluid flow through the plurality of selectively couplable fluid chambers by controlling pressure differential across a plurality of main diaphragms.

### TECHNICAL FIELD

Embodiments of the subject matter disclosed herein relate to thermal management and more particularly to a multi-valve integrated fluid distribution system for reconfigurable vehicle thermal management.

### BACKGROUND AND SUMMARY

Automotive thermal management systems utilize fluid to transfer heat from one system to another. In many automotive systems, actuated valves are used to control pressures or to control fluid flow. Direct solenoid flow valves, as often used, are simple in operation-utilizing a continuous direct current in the solenoid to allow or block fluid passage. Hydraulic flow valves controlled by a pilot pressure supplied by solenoid-actuated pilot valve assemblies are sometimes used to replace direct solenoid flow valves as a measure to reduce power consumption and valve size. In either type of valve, a solenoid is included with each of the valves included in the system which leads to increased manufacturing costs and weight of the package.

In order to serve required drive cycles and ambient conditions, reconfiguration of fluid flow within the vehicle is needed in order to divert cold, warm, and hot fluids to components in the vehicle, such as a battery system. Current thermal management systems for electric vehicles often utilize multiple individual valves to accomplish rerouting of fluid throughout the vehicle. The valves of such a distribution system occupy a significant amount of package space. The valves are often solenoid actuated, either direct or indirect as discussed, and therefore include coils (e.g., copper coils), which contribute to high manufacture and production costs as well as increased package weight and size.

The inventors herein have recognized the aforementioned issues and present a fluid distribution system for reconfigurable thermal management for an electric vehicle. The fluid distribution system disclosed comprises a fluid manifold with multiple sections arranged in layers and a pilot assembly that includes multiple manifold sections and a plurality of solenoid-actuated pilot valve assemblies that control position/status of a plurality of main diaphragms via changes in pressure differential. Each of the solenoid-actuated pilot valve assemblies includes a plurality of solenoids arranged side-by-side and a plurality of pilot diaphragms arranged side-by-side and positioned vertically below the plurality of solenoids.

A control board positioned directly above the one or more solenoids selectively provides current to the each of the plurality of solenoids in order to energize and/or de-energize the each of the plurality of solenoids. The plurality of solenoids control position/status of the plurality of pilot diaphragms and when one of the plurality of solenoid-actuated pilot valve assemblies is opened and/or closed, one or more of the plurality of main diaphragms may be opened and/or closed. Opening of a main diaphragm in this way allows for flow via an orifice that allows for fluid communication between selectively couplable fluid chambers that are arranged in separate sections of the fluid manifold. Similarly, closing of the main diaphragm disenables flow via the orifice, selectively decoupling fluid chambers. Each of the manifold sections includes one or more external fluid connections and one or more internal fluid connections, allowing for inflow and outflow of fluid via the manifold. A first section of the manifold is an inlet manifold that includes or is otherwise coupled to a plurality of inlet ports. A second section of the manifold is an outlet manifold that includes or is otherwise coupled to a plurality of outlet ports.

The multi-valve, multi-port design provides a compact, integrated package that provides for distribution and retrieval of fluid to and from multiple vehicle components. The fluid distribution system disclosed herein further includes an integrated pump, wherein an involute of the pump integrated into one of the manifold sections. In this way, weight of the pump may be reduced as the involute is manufactured along with the manifold.

As actuation of one of the plurality of solenoid-actuated pilot valve assemblies controls actuation of more than one of the main diaphragms, a single solenoid may control flow through/to more than one of the fluid chambers. In this way, number of solenoids demanded to reconfigure fluid flow may be reduced. Reduced number of solenoids, and consequently reducing amount of coils (e.g., copper coils) in the overall system, may decrease weight and size of the package.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 shows an example of an at least partially electrified vehicle.

FIG. 2A shows a perspective view of an example of a fluid distribution system.

FIG. 2B shows the fluid distribution system from a top down view.

FIG. 2C shows the fluid distribution system from a bottom up view.

FIG. 2D shows the fluid distribution system from a frontal view.

FIG. 2E shows the fluid distribution system from a rear view.

FIG. 2F shows the fluid distribution system from a first lateral view.

FIG. 2G shows the fluid distribution system from a second lateral view.

FIG. 3A shows an exploded view of a portion of the fluid distribution system.

FIG. 3B shows an exploded view of another portion of the fluid distribution system.

FIG. 4A shows an example of a manifold subassembly of the fluid distribution system.

FIG. 4B shows another example of the manifold subassembly of the fluid distribution system.

FIG. 5A shows a cross-sectional view of the fluid distribution system with the manifold subassembly removed.

FIG. 5B shows another cross-sectional view of the fluid distribution system with the manifold subassembly removed.

FIG. 5C shows another cross-sectional view of the fluid distribution system with the manifold subassembly in place.

FIG. 5D shows another cross-sectional view of the fluid distribution system.

FIG. 5E shows a perspective view of a cavity of the manifold subassembly.

FIG. 6 shows a perspective view of the manifold subassembly.

FIG. 7 shows an enclosure of a pilot assembly of the fluid distribution system.

FIG. 8 shows a cross-sectional perspective view of the fluid distribution system.

### DETAILED DESCRIPTION

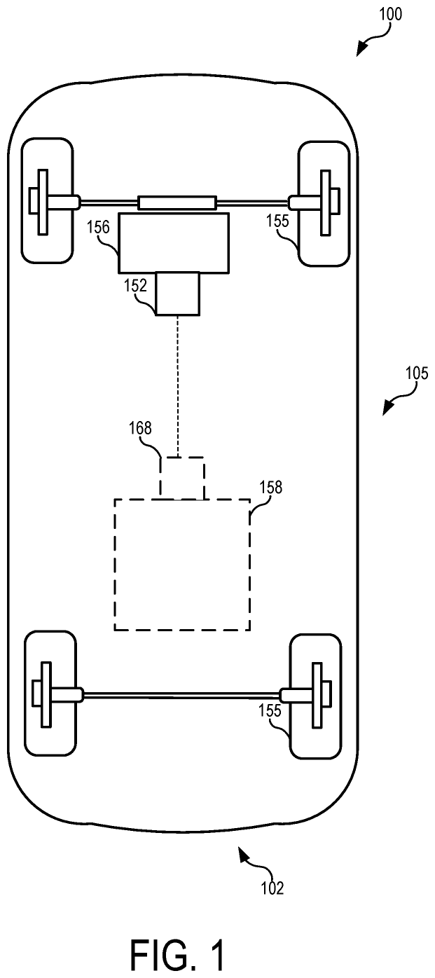

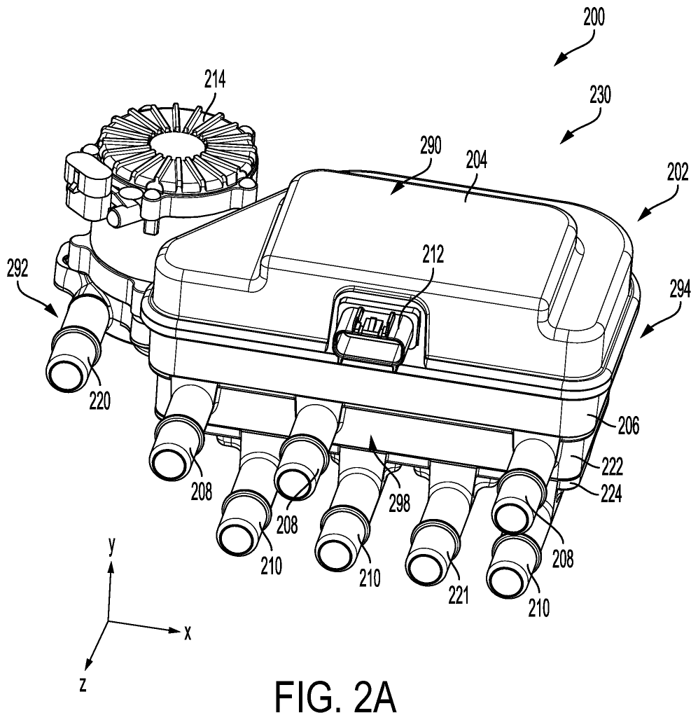

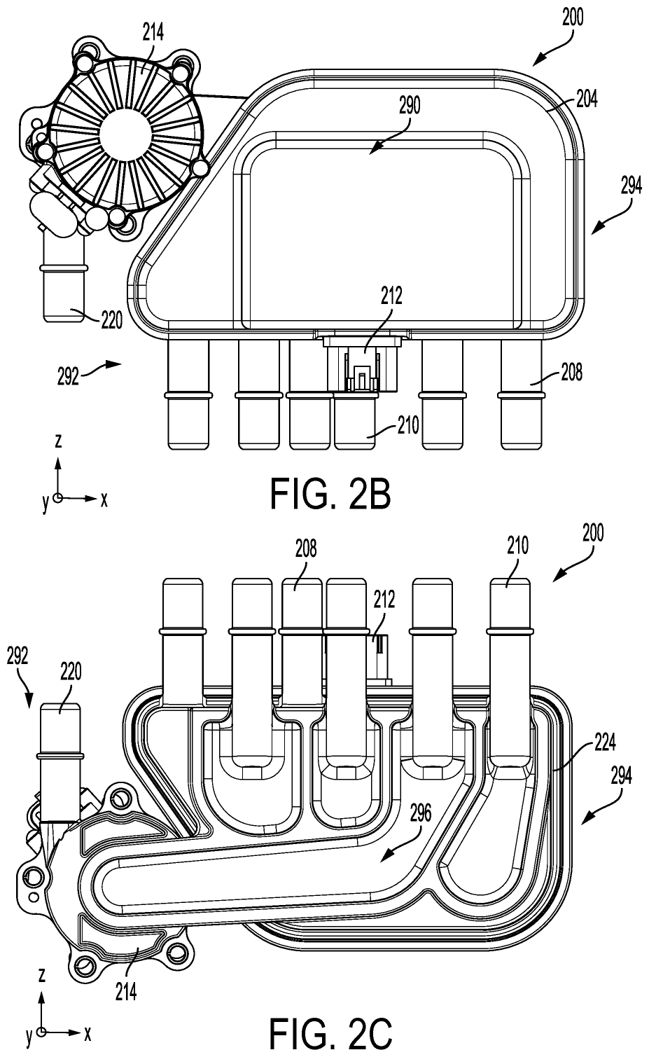

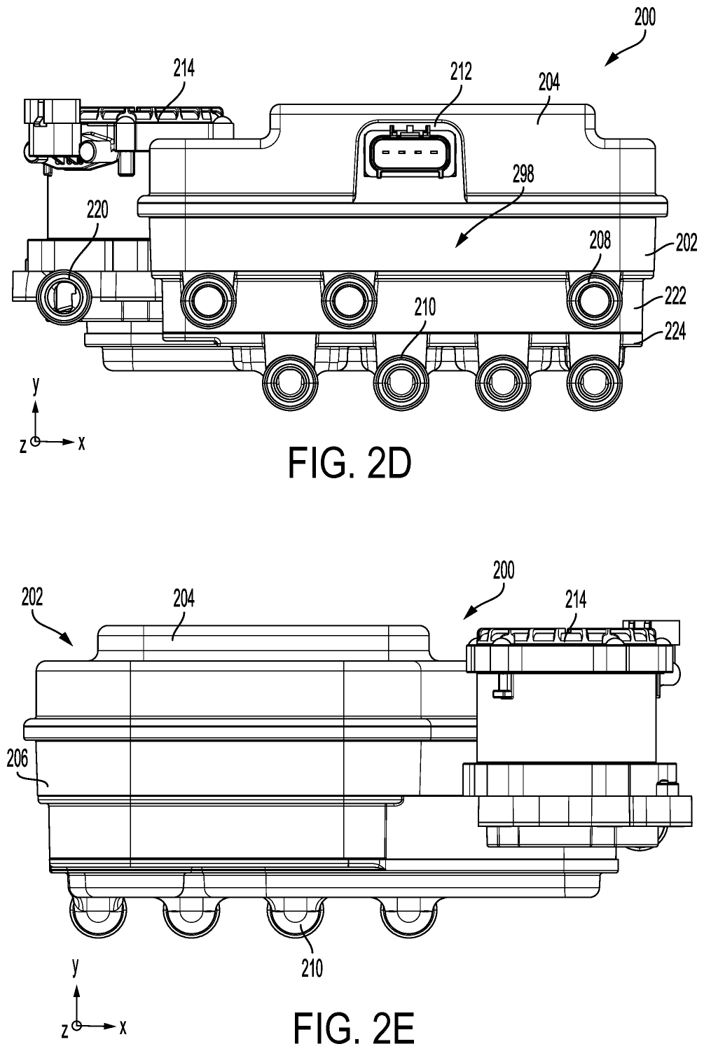

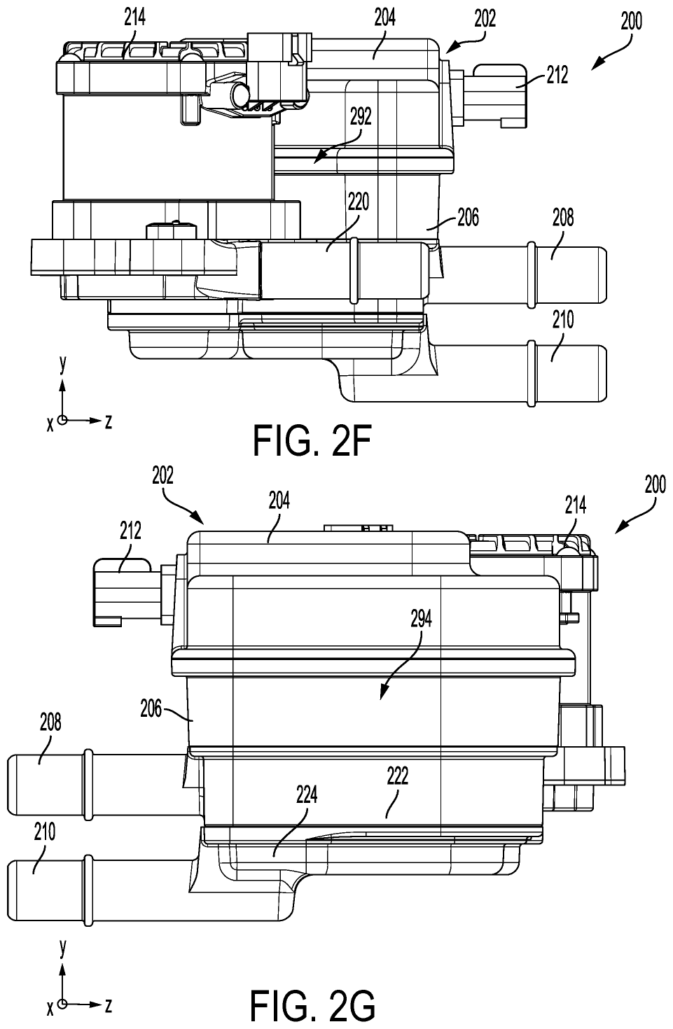

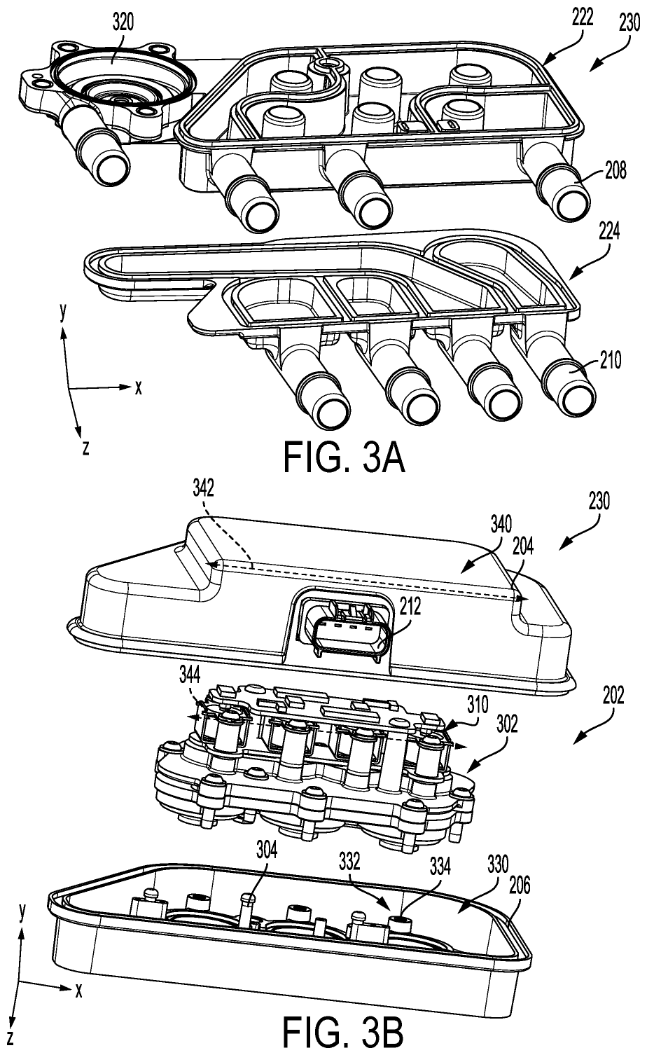

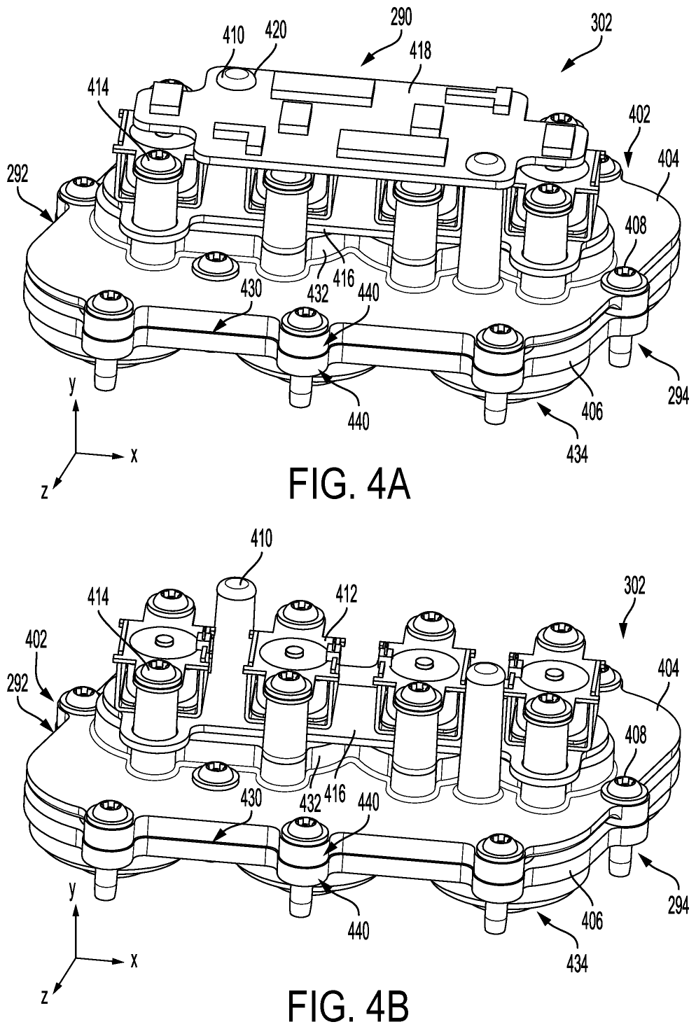

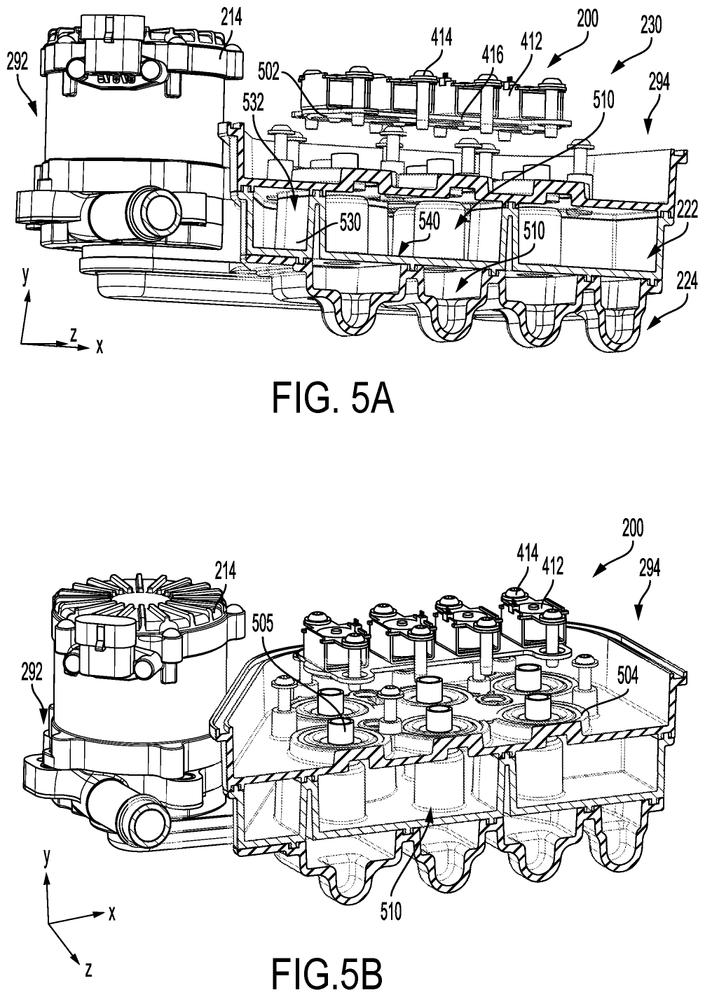

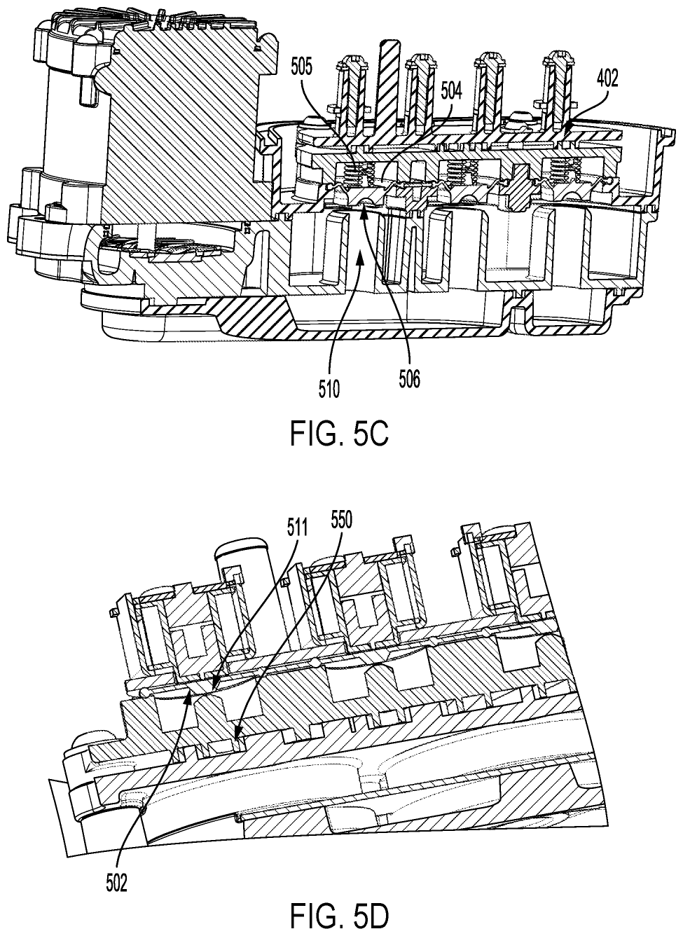

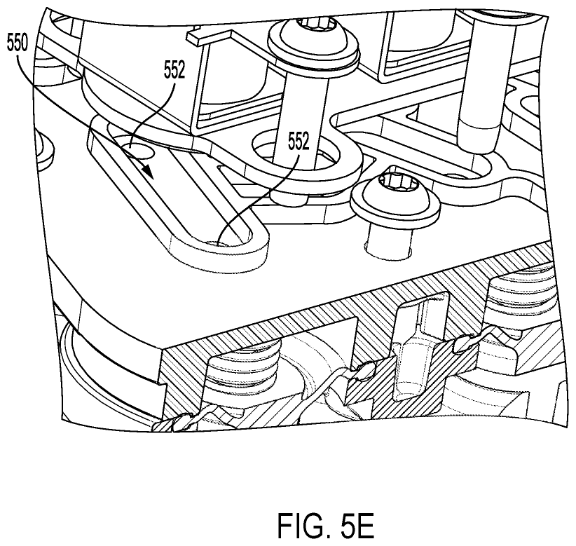

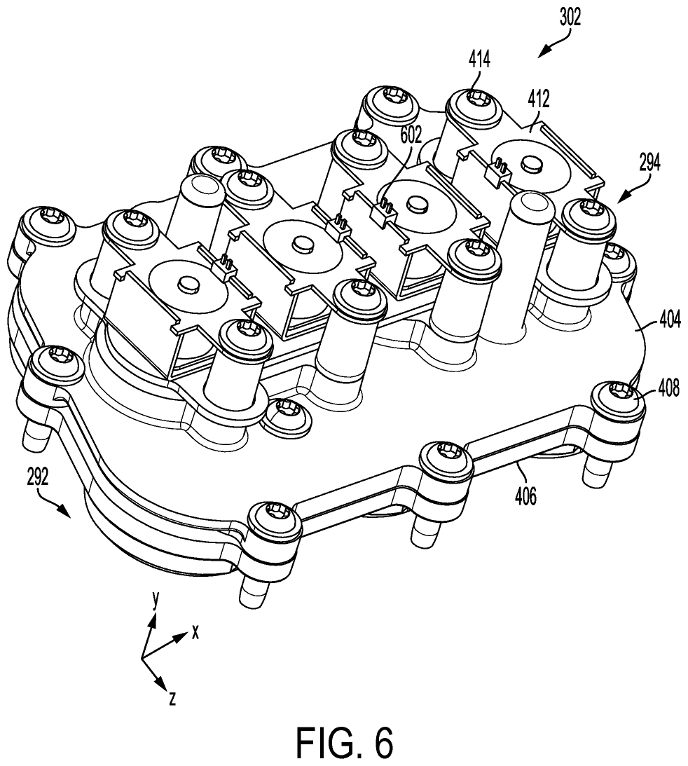

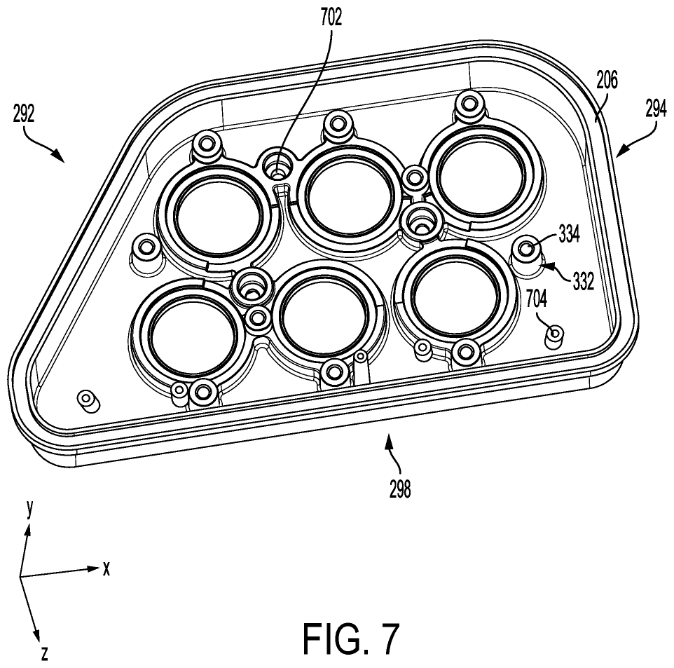

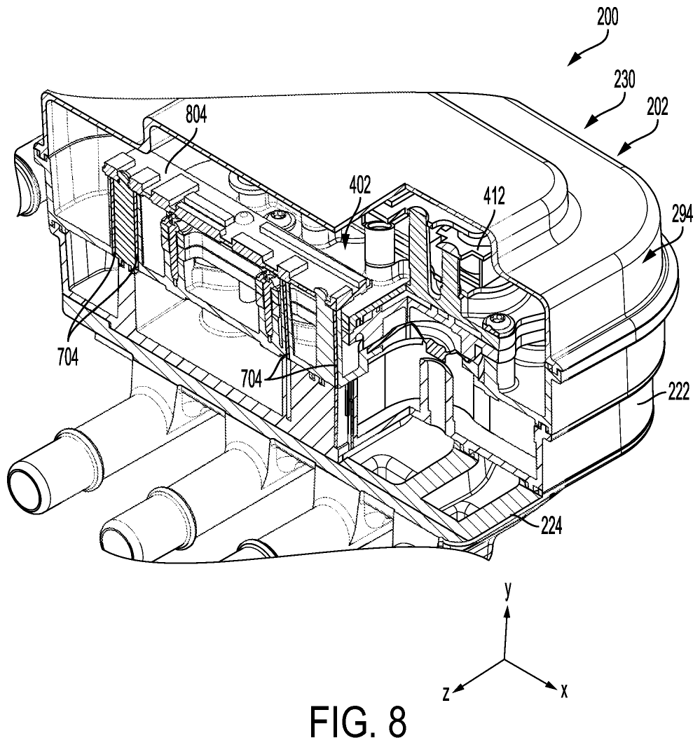

The following description relates to a multi-valve, multi-port integrated fluid distribution system for reconfigurable thermal management of a vehicle, such as an electric vehicle. The fluid distribution system comprises a manifold with first and second manifold sections and a pilot assembly that includes a manifold subassembly. The manifold subassembly comprises multiple sections arranged in two separate layers, the manifold layers having selectively couplable fluid chambers arranged on/within the separate layers. Fluid chambers arranged in separate layers are selectively couplable as controlled by solenoid-actuated pilot valve assemblies included and main diaphragms included in the manifold subassembly in order to direct fluid to a plurality of components of the vehicle via outlet ports. An example of the vehicle is depicted in schematic form in FIG. 1. External views of the fluid distribution system herein described are shown in FIGS. 2A-2G. Exploded views of the fluid distribution system, including the enclosure, cover, inlets/outlets, and manifold subassembly are shown in FIGS. 3A-3B. The manifold subassembly and components included therein is depicted in FIGS. 4A-4B. Internal components of the fluid distribution system are depicted in cross-sectional views wherein the manifold subassembly has been removed for visualization in FIGS. 5A-5E. A perspective view of the manifold subassembly is shown in FIG. 6. The enclosure of the pilot assembly is shown in FIG. 7. Pressure sensor ports and connected circuit board are depicted in a cross-sectional view of the fluid distribution system in FIG. 8.

Turning now to FIG. 1, an example vehicle 105 is shown. In some examples, vehicle 105 may be a hybrid vehicle with multiple sources of torque available to one or more vehicle wheels 155. In other examples, vehicle 105 may be an all-electric vehicle, powered exclusively by an energy storage device such as a battery assembly, herein referred to as a battery 158. In the example shown, vehicle 105 includes an electric machine 152 which may be a motor or a motor/generator. Electric machine 152 receives electrical power from the battery 158 which is converted to rotational energy, e.g., torque, at a transmission 156. The torque is delivered to vehicle wheels 155. Electric machine 152 may also be operated as a generator to provide electrical power to charge battery 158, for example, during a braking operation.

While electric machine 152 is shown providing rotational energy to the vehicle wheels 155 proximate to a front end 100 of vehicle 105, e.g., at front wheels of the vehicle, via the transmission 156, it will be appreciated that the transmission 156 may be alternatively arranged at rear wheels of vehicle 105, e.g., vehicle wheels 155 proximate to a rear end 102 of the vehicle, and energy from the electric machine 152 transmitted thereto. Furthermore, in other examples, each of the front wheels and the rear wheels may be coupled to individual transmissions, such as when vehicle 105 is configured with all-wheel drive.

In some examples, the vehicle 105 may further comprise a thermal management system 168. The thermal management system 168 may be in communication with the battery 158 to provide fluid of variable temperatures to alter a temperature of the battery 158. The thermal management system 168 may be in further communication with the electric machine 152, as well as other components not depicted. The thermal management system 168 may be configured to control external and internal temperature conditions as well as regulating optimal temperature of the battery 158, the electric machine 152, and more. In some examples, the thermal management system 168 includes a fluid distribution system for reconfiguring fluid of variable temperatures to components of the vehicle 105.

The battery assembly (e.g., the battery 158) may be a single battery or may include a plurality of cells or modules electrically coupled to one another. A quantity of the plurality of cells may determine a capacity of the battery 158. The battery 158 may be configured with a high power-to-weight ratio, high specific energy, and high energy density to provide power over long periods of time. Examples of battery types which may be used in vehicle 105 include lithium-ion, lithium polymer, lead-acid, nickel-cadmium, and nick-metal hydride batteries, amongst others. The battery 158 may be a rechargeable battery, such as a battery formed of lithium-ion cells. When configured as a rechargeable battery, the battery 158 may be recharged by regenerative braking operations or an external power source. Battery performance and life may depend on the applied load (and therefore on the charge/discharge rate), as well as operating conditions (such as temperature). The battery 158 may work efficiently over a range of discharge rates (e.g., C/8-2C), within a target range of operating temperatures (typically from 20° C. to 45° C.), and at relatively uniform temperature (e.g., temperature uniformity of less than 5° C.).

Temperature and/or pressure within the battery 158 may rise to a level that is not sustainable for operation of the battery 158 or otherwise results in degradation of the battery 158. The thermal management system 168 as well as the fluid distribution system therein may regulate and/or maintain temperatures within the battery 158, as well as other components discussed herein, in order to reduce degradation and increase longevity of the battery 158.

Turning now to FIGS. 2A-2G, external views of an example fluid distribution system 200 are shown. FIG. 2A specifically depicts the fluid distribution system 200 from a perspective view, FIG. 2B specifically depicts the fluid distribution system 200 from a top down perspective, FIG. 2C specifically depicts the fluid distribution system 200 from a bottom up view, FIG. 2D specifically depicts the fluid distribution system 200 from a frontal view, FIG. 2E specifically depicts the fluid distribution system 200 from a rear view, FIG. 2F specifically depicts the fluid distribution system 200 from a first lateral view, and FIG. 2G specifically depicts the fluid distribution system 200 from a second lateral view. An axis system is provided in FIGS. 2A-2G, as well as FIGS. 3A-8, for reference. The y-axis may be a vertical axis (e.g., parallel to a gravitational axis), the x-axis may be a lateral axis (e.g., horizontal axis), and/or the z-axis may be a longitudinal axis, in one example. However, the axes may have other orientations in other examples.

The fluid distribution system 200 may be part of the thermal management system 168 of the vehicle 105 of FIG. 1. The fluid distribution system 200 may comprise a fluid manifold 230, which comprises a first section 222, and a second section 224, a pilot assembly 202, and a pump 214. The first section 222 may be positioned closer to a top end 290 of the fluid distribution system 200 than the second section 224. The first and second sections 222, 224 may be coupled together when the fluid distribution system 200 is assembled. When assembled, the top end 290 of the second section 224 may be coupled to a bottom end 296 of the first section 222. A plurality of inlet ports 208 and a plurality of outlet ports 210 may be a portion of or otherwise coupled to the first section 222 and the second section 224. In some embodiments, each of the plurality of inlet ports 208 may be coupled to the first section 222 and each of the plurality of outlet ports 210 may be coupled to the second section 224. In such embodiments, the first section 222 may be an inlet manifold and the second section 224 may be an outlet manifold. However, other configurations of inlet ports and outlet ports have been contemplated. The pilot assembly 202 may be integrated into the fluid manifold 230. In an example, being integrated into may include being housed within and coupled to receded regions of a mold of the fluid manifold 230, as will be further explained.

The plurality of inlet ports 208 and plurality of outlet ports 210 may be positioned at and/or protrude from a front 298 of the fluid distribution system 200. “Front” of the fluid distribution system 200 is herein used illustratively and is not meant to describe orientation of the fluid distribution system 200 when positioned within the vehicle. In some examples, the first section 222 may comprise three inlet ports and the second section 224 may comprise three outlet ports. Each of the plurality of inlet ports 208 and the plurality of outlet ports 210 may be in fluid communication with chambers of the pilot assembly 202. A pump inlet port 221 may be in fluid communication with the pump 214 such that the pump 214 receives fluid from the pump inlet port 221. Further, each of the inlet ports 208 and outlet ports 210 may be in fluid communication with one or more components of the vehicle such as a Heating. Ventilation, and Air Conditioning (HVAC) system, an Energy Storage System (ESS), and the like. In some examples, a vehicle component may receive fluid from the fluid distribution system 200 via one of the outlet ports and may deliver fluid to the fluid distribution system 200 via one of the inlet ports.

The first section 222 and the second section 224 may both include one or more external fluid connections and one or more internal fluid connections. In this way, fluid from other components in the vehicle may be directed into and/or out of the fluid distribution system 200 and through internal fluid passages within the fluid distribution system 200. In this way, the fluid manifold 230 may combine a plurality of ports with a plurality of solenoid valves housed therein into a single package to allow for fluid to be distributed throughout the vehicle. In some examples, the fluid distribution system 200 may be paired with a second fluid distribution system to create a fluid management system.

The pump 214 may pressurize fluid entering and/or being outputted from the fluid distribution system 200 via the plurality of inlet ports 208 and the plurality of outlet ports 210. A pump outlet port 220 is included with the pump 214. Direction of flow and which of the plurality of inlet ports 208 and plurality of outlet ports 210 are used may be determined based on the needs of the various vehicle systems, taking into account prioritization factors. For example, some systems may have higher priority warming/cooling needs than others. Which valve opens and/or closes at a given time is defined by an intelligent control system included in the vehicle, which may actuate a given solenoid based on input parameters received from temperature, pressure, and/or other sensors located in different places and associated with different systems within the vehicle. The pump 214 may be an electronically commuted centrifugal pump or other type of electric or non-electric (e.g., mechanical or other) fluid pump that provides a plurality of components (e.g., the battery 158 of FIG. 1) of the vehicle 105 with necessary fluid flow. The pump 214 may be in communication with a power source, such as battery 158 of the vehicle 105.

The pump 214 may be positioned on a first side 292 of the fluid manifold 230, opposite a second side 294. The fluid manifold 230, e.g., either the first or second sections 222, 224, may be integrated with or otherwise coupled to the pump 214. As an example, the first section 222 of the fluid manifold 230 may be formed as a mold that includes an involute of the pump 214 such that the pump 214 is integrated into the fluid distribution system 200, as shown in the bottom up view of FIG. 2C. Integrating the pump 214 into the fluid distribution system 200 may reduce weight of the pump 214 as portions of the pump 214 may be manufactured with the fluid manifold 230.

The pilot assembly 202 may comprise a cover 204 and a pilot assembly enclosure 206, as well as a manifold subassembly housed within the pilot assembly enclosure 206 and the cover 204 when the pilot assembly enclosure 206 and the cover 204 are coupled together. Each of the components of the pilot assembly 202 may be manufactured separately and then assembled and tested as a unit prior to being coupled to the first and second sections 222, 224 of the fluid manifold 230. In this way, errors in manufacturing or components may be determined prior to assembly of the fluid distribution system 200, reducing downstream effects during production.

When assembled, the top end 290 of the first section 222 may be coupled to the bottom end 296 of the pilot assembly enclosure 206 and the top end 290 of the pilot assembly enclosure 206 may be coupled to the bottom end 296 of the cover 204. The cover 204 may include a connector 212 that connects the fluid manifold 230 to another component within the vehicle. In some examples, the connector 212 may be an electrical interface that couples a control board (e.g., control board 418 referenced with respect to FIG. 4A) to an electrical system of the vehicle, thereby providing current to the control board. The connector 212 may be positioned at the front 298 of the cover 204.

The first section 222, the second section 224, the pilot assembly enclosure 206 and the cover 204 may include joint surfacing that is planar. In this way, welding to couple the second section 224 to the first section 222, the first section 222 to the pilot assembly enclosure 206, and the pilot assembly enclosure 206 to the cover 204 is simplified, reducing manufacturing time.

Exploded views of the fluid manifold 230 of the fluid distribution system 200 are shown in FIGS. 3A and 3B. In some examples, an involute 320 of the pump 214 may be integrated as part of a mold of the first section 222, which, as noted, may reduce weight of the pump 214. The pilot assembly 202 may house a manifold subassembly 302. The manifold subassembly 302 may couple to the pilot assembly enclosure 206 via pins 304, thereby reducing shifting of the manifold subassembly 302 within the pilot assembly enclosure 206 which may reduce degradation to the manifold subassembly 302. The cover 204, when coupled to the pilot assembly enclosure 206, may further protect the manifold subassembly 302 from degradation.

The manifold subassembly 302 may comprise a plurality of solenoid-actuated pilot valve assemblies 310. Solenoid valves that are pilot-operated may provide increased flow capability, reliability, and lower power consumption in comparison to direct-acting solenoid valves. As will be described in greater detail below, each of the plurality of solenoid-actuated pilot valve assemblies 310 may comprise a solenoid and a pilot diaphragm. Further, the plurality of solenoid-actuated pilot valve assemblies 310 may be housed in a common assembly. In an example, the common assembly may be a unitary housing (e.g., the pilot assembly 202) that at least partially encloses each of the plurality of solenoid-actuated pilot valve assemblies 310. Each of the solenoid-actuated pilot valve assemblies 310 may be mounted directly to components of the fluid manifold 230, thereby integrating the plurality of solenoid valves into the fluid distribution system 200. As each of the solenoid-actuated pilot valve assemblies are integrated with the manifold subassembly 302 (e.g., fixedly coupled to), only one control board (not shown in FIGS. 3A-3B) and electrical interface (e.g., the connector 212) are demanded, which may decrease overall package size and weight, increasing versatility of use in various vehicle applications.

As shown in FIG. 3B, the pilot assembly enclosure 206 may include a recessed region 330 and a plurality of protrusions 332. Each of the plurality of protrusions 332 may couple the manifold subassembly 302 to the pilot assembly enclosure 206, maintaining contact and position of the manifold subassembly 302. Each of the plurality of protrusions 332 may include a central hole 334 into which a corresponding protrusion or fastener of the manifold subassembly 302 may insert into in order to couple the manifold subassembly 302 to the pilot assembly enclosure 206. Similarly, the cover 204 may include a raised region 340 configured to accommodate the top end 290 of the manifold subassembly 302 when the fluid manifold 230 is assembled. As such, a first width 342 of the raised region 340 may be larger than a second width 344 of the manifold subassembly 302.

Turning now to FIGS. 4A and 4B, the manifold subassembly 302 is shown. In some examples, the manifold subassembly 302 comprises a upper section 404 of a pilot manifold 402, a lower section 406 of the pilot manifold 402, a first plurality of fasteners 408, a plurality of solenoids 412, a second plurality of fasteners 414, a pressure plate 416, a control board 418, and a plurality of pilot diaphragms (not shown). The upper section 404 and the lower section 406 are separated by a first coupling plane 430. FIG. 4A depicts the manifold subassembly 302 with the control board 418 positioned atop the plurality of solenoids 412 while FIG. 4B depicts the manifold subassembly 302 without the control board 418.

The control board 418 may include one or more tooling holes 420 (e.g., mounting holes) that align with one or more protrusions 410 of the upper section 404 of the pilot manifold 402. The one or more protrusions 410 may protrude axially upwards (e.g., in a positive vertical direction) away from the upper section 404. Each of the one or more protrusions 410 may extend through one of the one or more tooling holes 420, thereby maintaining a lateral and longitudinal position of the control board 418 as it is assembled atop the plurality of solenoids 412. Maintaining a position of the control board 418 during assembly may reduce degradation to the control board 418 from positioning errors and/or contact with other components. As will be described further below, the control board 418 may be removably coupled to the plurality of solenoids 412 via pin connectors.

In some examples, each of the plurality of solenoids 412 may comprise an electromagnetic coil (not shown) that may be energized or de-energized based on current provided by the control board 418. The plurality of solenoids 412 may be arranged side-by-side such that each of the plurality of solenoids 412 is laterally adjacent to at least one other solenoid. The plurality of solenoids 412 may be positioned directly on top of the pressure plate 416, thereby maintaining a stable position of the pressure plate 416. The upper section 404 of the pilot manifold 402 may include a raised region 432 positioned for the pressure plate 416 to be in direct face sharing contact with. The plurality of solenoids 412 may also maintain pressure between the pressure plate 416 and components directly underneath, such as the raised region 432 of the upper section 404, thereby reducing number of fasteners demanded in the fluid distribution system 200 to maintain positions of components therein. The lower section 406 may include a recessed region 434 positioned to couple a plurality of main diaphragms (not shown in FIGS. 4A-4B) to the lower section 406.

The first plurality of fasteners 408 may couple the upper section 404 of the pilot manifold 402 and the lower section 406 of the pilot manifold 402 together. The second plurality of fasteners 414 may couple the plurality of solenoids 412 to the upper section 404, maintaining a stable position of the plurality of solenoids 412. The pressure plate 416 may be positioned between the plurality of solenoids 412 and the upper section 404. The upper and lower sections 404, 406 of the pilot manifold 402 may be configured with an irregular shape that includes a plurality of rounded lateral protrusions 440 with central holes (not shown). Each of the first plurality of fasteners 408 may extend through a pair of corresponding central holes of the plurality of rounded lateral protrusions 440, the pair including a central hole of a rounded lateral protrusion of the upper section 404 and a central hold of a rounded lateral protrusion of the lower section 406. Rounded lateral protrusions of the upper section 404 and rounded lateral protrusion so the lower section 406 may couple at the first coupling plane 430. Further, in some examples, each of the first plurality of fasteners 408 may correspond to one of the plurality of protrusions 332 with central holes 334 such that each of the plurality of fasteners 408 is a point of fastening between the pilot manifold 402 and the pilot assembly enclosure 206.

In some examples, the control board 418 may include a plurality of sensors positioned within the control board 418 such that when the control board 418 is positioned atop the plurality of solenoids 412, each of the plurality of sensors is directly above one of the plurality of solenoids 412. The sensors may sense pintle position of each of the plurality of solenoids 412. In some examples, the sensors may be Hall effect sensors. The plurality of sensors may allow for detection of solenoid position errors during operation which may decrease possibility of erroneous fluid flow to components of the vehicle.

As seen in FIGS. 5A-5E, the fluid distribution system 200 further includes a plurality of pilot diaphragms 502 and a plurality of main diaphragms 504. FIG. 5A specifically depicts the plurality of pilot diaphragms 502 while the pilot manifold 402 has been removed for visualization and FIG. 5B specifically depicts the plurality of main diaphragms 504 while the pilot manifold 402 has been removed for visualization. FIG. 5C specifically depicts the plurality of main diaphragms 504 with the pilot manifold 402 in place. FIG. 5D specifically depicts a cross-section of the pilot manifold 402 showing the plurality of pilot diaphragms 502 and a pressure differential chamber. FIG. 5E specifically shows an example of a cavity in communication with a pressure differential chamber (not shown in FIG. 5E). The pilot diaphragms 502, along with the plurality of solenoids 412, make up a plurality of solenoid-actuated pilot valve assemblies. The pilot diaphragms 502 and the main diaphragms 504 may be formed, respectively, as single injection molded pieces of material (e.g., a single injection mold), which may reduce manufacturing time and installation time during assembly of the fluid distribution system 200.

The pilot diaphragms 502 may be arranged side-by-side, similar to the plurality of solenoids 412, when formed as a single injection mold. Each of the pilot diaphragms 502 may be positioned directly below one of the plurality of solenoids 412 and may be in communication with the plurality of solenoids 412 to form the solenoid-actuated pilot valve assemblies 310. For example, a solenoid, when energized via current from the control board 418, opens a pilot diaphragm (e.g., the pilot diaphragm is pulled upwards or pushed downwards) to allow for a change in pressure differential across one or more main diaphragms. Each of the solenoid-actuated pilot valve assemblies 310 includes one solenoid and one pilot diaphragm. For example, a fluid distribution system 200 that includes four solenoid-actuated pilot valve assemblies 310, as depicted in FIG. 4B, may include four solenoids and four pilot diaphragms. A quantity of solenoid-actuated pilot valve assemblies 310 in the fluid distribution system 200 may not be equal to a quantity of main diaphragms 504, however. For example, a fluid distribution system that includes four solenoid-actuated pilot valve assemblies may include six main diaphragms 504, as depicted in FIG. 5B.

Each of the plurality of main diaphragms 504 may include a valve spring 505 that when contracted or extended as a result of pressure, changes a status of one of the plurality of main diaphragms 504 from open to closed or from closed to open in order to disenable or enable fluid flow through an orifice, thereby selectively coupling or decoupling fluid chambers. Regardless of the quantity of solenoid-actuated pilot valve assemblies 310 and/or the quantity of main diaphragms 504, the plurality of inlet ports 208 and the plurality of outlet ports 210 may be integrated into the fluid manifold 230 (e.g., formed as part of the mold of the first and second sections 222, 224 or otherwise fixedly coupled to the fluid manifold 230). In this way, quantity of valves and/or main diaphragms may be increased or decreased to fit an application without demanding a change in placement of ports.

The pilot diaphragms 502 may be positioned directly underneath and in direct contact with the pressure plate 416, the pressure plate 416 holding the pilot diaphragms 502 in place. The pilot diaphragms 502 may further be positioned directly on top of (e.g., in face sharing contact with) the upper section 404 (not shown in FIGS. 5A-5B). The pressure plate 416 may maintain a position of the pilot diaphragms 502 between the upper section 404 and the pressure plate 416. Close proximity between the pilot diaphragms 502 and the plurality of solenoids 412 may enable for a single printed circuit board (PCB) (e.g., the control board 418) to control each of the plurality of solenoid-actuated pilot valve assemblies.

The plurality of main diaphragms 504 may be positioned around a plurality of orifices 506. Each of the plurality of orifices 506 may be in fluid communication with one or more of a plurality of selectively couplable fluid chambers 510. The plurality of selectively couplable fluid chambers 510 may be arranged in layers, e.g., some of the plurality of selectively couplable fluid chambers 510 included in the first section 222 and other of the plurality of selectively couplable fluid chambers 510 included in the second section 224, the layers of selectively couplable fluid chambers 510 arranged on opposing ends of a second coupling plane 540. Fluid chambers arranged in separate layers may be in fluid communication, for example, a first fluid chamber arranged above the second coupling plane 540 may be in fluid communication with a second fluid chamber arranged below the second coupling plane 540.

The first section 222 may include a plurality of walls 530 that separate a plurality of rooms 532 from one another. Each of the plurality of rooms may house one or more of the plurality of selectively couplable fluid chambers 510 of the first section 222. For example, a first pair of selectively couplable fluid chambers 510 comprising the first fluid chamber arranged above the coupling plane 540 and the second fluid chamber below the coupling plane 540, may be housed within a first pair of rooms 532, the first chamber housed in a first room and the second chamber housed in a second room. Each pair of fluid chambers may be housed within a different pair of rooms. In some examples, each of the plurality of selectively couplable fluid chambers 510 and/or the plurality of rooms 532 may be in fluid communication with an inlet or an outlet of the first or second sections 222, 224 such that fluid may be outputted from or received into a fluid chamber or room through an outlet or inlet, respectively.

The plurality of main diaphragms 504 may be pneumatically or hydraulically operated to enable or disenable fluid flow through the plurality of orifices 506, the main diaphragms 504 acting as on/off control valves. As discussed, the plurality of main diaphragms 504 open and/or close based on pressure differential controlled by the solenoid-actuated pilot valve assemblies 310. Actuation (e.g., opening and/or closing) of one of the solenoid-actuated pilot valve assemblies 310 may result in opening and/or closing of one or more of the main diaphragms 504. A single pilot diaphragm may be in fluid communication with a pressure differential chamber 511 that is in communication with multiple main diaphragms via a cavity 550. Each cavity 550, as seen in FIG. 5E, may include one or more ports 552 that are each in fluid communication with a main diaphragm. In this way, a single pilot diaphragm may open or close one or more main diaphragm. In some examples, a cavity 550 may include only one port 552 in communication with a main diaphragm. Pilot diaphragms in fluid communication with a cavity that includes only one port may change pressure differential to open or close a single main diaphragm. In some examples, increase in pressure differential across the plurality of main diaphragms 504 may cause the main diaphragms 504 to open to enable flow through the plurality of orifices 506. Pressure acting upon or removed from one of the diaphragms may cause the diaphragm to either open or close in order to enable or disenable flow. Which of the plurality of main diaphragms 504 are opened may control which of the plurality of inlet ports and outlet ports deliver and/or receive fluid.

In order to reconfigure distribution of variable temperature (e.g., cold, warm, hot) fluid, the pilot assembly 202 may use the plurality of solenoid-actuated pilot valve assemblies 310 in order to control pressure differential across each of the plurality of main diaphragms 504 to cause them to open and close. The plurality of solenoids 412 may be energized or de-energized, causing a change in position of one or more of the pilot diaphragms 502, as previously described. Change in position of a pilot diaphragm may cause a change in pressure differential across one or more main diaphragms 504 that opens or closes one or more of the plurality of orifices 506. Opening and/or closing one or more of the plurality of orifices 506 may selectively couple and/or decouple sets of fluid chambers. Selective opening and closing of each of the main diaphragms 504 may result in a fluid flow between inlet and outlet ports of each of the various vehicle systems that route through the fluid distribution system 200. For example, in a normal state, pressure from the pump 214 may maintain an open position of the pilot diaphragms 502, which in turn results in the main diaphragms 504 being closed and therefore no flow is permitted between inlet and outlet ports via the fluid chambers. When thermal, pressure, or other parameter detected via a sensor, as described with respect to FIGS. 2A-2G, dictate that flow is to occur to and/or from one or more of the vehicle systems routed through the fluid distribution system 200, one or more of the solenoids is actuated. When actuated, corresponding pilot diaphragm(s) may close, and closure of the corresponding pilot diaphragm(s) may result in opening of corresponding main diaphragm(s). When the corresponding main diaphragm(s) are in the open position, fluid flow is allowed between inlet and outlet ports for the dictated one or more vehicle systems. Differential pressure for the pilot assembly 202 that is used to open and/or close the main diaphragms 504 may come from the fluid of the plurality of inlet ports 208 of the first section 222 of the fluid manifold 230 and the pump inlet port 221.

As actuation of one of the solenoid-actuated pilot valve assemblies 310 may affect more than one of the plurality of main diaphragms 504, number of solenoids demanded may be reduced, thereby reducing overall weight of the package (e.g., by reducing amount of copper, or other suitable metal, demanded to manufacture a solenoid). Additionally, the multi-valve arrangement, wherein the plurality of fluid chambers are arranged in layers and in fluid communication with a plurality of inlet and outlet ports arranged in layers, may reduce overall package size, therefore increasing compactness and versatility for installation options.

As noted, in some examples, multiple of the plurality of main diaphragms 504 may be controlled by one of the solenoid-actuated pilot valve assemblies 310 In this way, selective coupling of multiple sets of fluidically connected fluid chambers may be realized with a single signal and coil (e.g., from a solenoid). In this way, number of solenoids demanded to reconfigure distribution of fluid may be further reduced, thereby further reducing weight of the overall system.

FIG. 6 shows the manifold subassembly 302. Pin connectors 602 may be included with each of the plurality of solenoids 412 such that each of the plurality of solenoids 412 includes a pin connector to connect to the control board 418. In this way, a single control board 418 may be used to control the plurality of solenoids 412. The pin connectors 602 may project axially upwards (e.g., in a positive direction along the vertical axis) from the plurality of solenoids 412. When the control board 418 is positioned in direct face sharing contact with the plurality of solenoids 412, the pin connectors 602 may connect directly to the control board 418 in order to adhere the control board 418 to the plurality of solenoids 412 and electrically couple the control board 418 to the plurality of solenoids 412 to allow for transfer of current from the control board 418 to the plurality of solenoids 412. Further, the side-by-side configuration of the plurality of solenoids 412 may allow for a reduced size of the control board 418. The pin connectors 602 may reduce demand for soldering between the control board 418 and the plurality of solenoids 412, thereby reducing weight of the system (e.g., by reducing amount of tin, lead, and/or other metals used for soldering.)

FIG. 7 shows the pilot assembly enclosure 206 disassembled from the manifold subassembly 302 and the cover 204. In some examples, the pilot assembly enclosure 206 may include a plurality of particle filters 702. The plurality of particle filters 702 may be positioned within the pilot assembly enclosure 206 to align with connection points to the manifold subassembly 302. The plurality of particle filters 702 may be configured to prevent debris from entering the pilot assembly enclosure 206 and/or the plurality of fluid chambers 510, which may reduce degradation or clogging of small passages from debris. Additionally, the plurality of particle filters 702, by preventing debris from entering the pilot assembly enclosure 206, may reduce leaks and inaccurate control of pilot diaphragm fluid flow that would result from contamination.

The pilot assembly enclosure 206 may further include a plurality of pressure ports 704. The plurality of pressure ports 704, as is further described below, may allow for a plurality of pressure sensors (not shown) to monitor pressure in various fluid chambers and/or rooms. In some examples, each of the plurality of pressure ports 704 may feed from a pressure sensor located in one of the plurality of rooms 532, thereby allowing monitoring of pressure within each of the plurality of rooms 532 separately.

FIG. 8 shows a cross-sectional view of the fluid distribution system 200 in an assembled state. The pilot assembly 202 may further house a circuit board 804. The plurality of pressure ports 704 leading from the first and second sections 222, 224 may lead to a common location adjacent to the plurality of solenoids 412. The plurality of pressure ports 704 may enable a plurality of pressure sensors (not shown) included in the pilot assembly 202 (e.g., included in the circuit board 804 and/or in the control board 418) to sense pressure to determine performance and detect any errors in valve state. The circuit board 804 may process data provided by the plurality of pressure sensors to determine if a change in a state of one or more solenoid valves is warranted. The circuit board 804 may include sensors as well that provide data to the vehicle's intelligent control system, thereby enabling the intelligent control system to detect solenoid state and predict fault conditions. In this way, the fluid distribution system 200 may self-detect errors in performance or actuation based on sensor data acquired by the circuit board 804 and the plurality of pressure ports 704 and pressure sensors.

In some examples, the fluid distribution system 200 may include a fluid reservoir, bottle, or tank that is attached to the pilot assembly or otherwise integrated into the system. The fluid reservoir, bottle, or tank may be accessed in order to pull fluid into the system and/or into the pump 214. In other examples, the fluid reservoir, bottle, or tank may be located external to the fluid distribution system 200 and accessed via the plurality of inlet ports 208 and/or the pump inlet port 221.

A technical effect of the fluid distribution system herein described is that a compact, integrated fluid distribution assembly is provided that includes a plurality of valves and a plurality of ports into a single unit. The fluid distribution system, which includes a plurality of pilot-actuated solenoid valves, reduces quantity of solenoids demanded to reconfigure fluid distribution throughout a vehicle while maintaining number of inlet and outlet ports. The multi-section and multi-layered design allows for directional fluid flow between multiple sets of fluid chambers arranged in separate layers of the manifold from a single signal and solenoid. Reduction in quantity of solenoids, as well as integrating portions of a pump (e.g., an involute of the pump) into the fluid manifold, reduces weight and size of the package. Reduced weight and size of the package increases overall versatility and usability of the system in various vehicle platforms, including those with space constraints.

In another representation, a method for a fluid distribution system for reconfigurable thermal management of a vehicle comprises receiving fluid into a first section of a fluid manifold via a plurality of inlets, controlling pressure differential across a plurality of main diaphragms by opening and/or closing one or more solenoid-actuated pilot valve assemblies in response to energization and/or de-energization of one or more solenoids via a control board, opening one or more main diaphragms in response to a change in pressure differential resultant from the opening of the one or more solenoid-actuated pilot valve assemblies, selectively coupling one or more pairs of fluid chambers in response to opening of the one or more main diaphragms, and outputting fluid to one or more components of the vehicle via one or more outlets in fluid communication with the one or more fluid chambers.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The disclosure also provides support for a fluid distribution system, comprising: a fluid manifold having a plurality of ports in fluid communication with a plurality of selectively couplable fluid chambers, a pilot assembly comprising a plurality of solenoid-actuated pilot valve assemblies controlling fluid flow between the plurality of selectively couplable fluid chambers, wherein: the plurality of selectively couplable fluid chambers are arranged in a first section and a second section of the fluid manifold, the first section and the second section separated by a coupling plane, fluid chambers in fluid communication are arranged in opposing ends of the coupling plane, the plurality of solenoid-actuated pilot valve assemblies are housed in a common assembly and mounted directly to the fluid manifold, and one or more of the plurality of solenoid-actuated pilot valve assemblies controls flow through at least one of the selectively couplable fluid chambers. In a first example of the system, the plurality of solenoid-actuated pilot valve assemblies comprise a plurality of solenoids and a plurality of pilot diaphragms. In a second example of the system, optionally including the first example,: the plurality of pilot diaphragms are arranged side-by-side and formed as a single injection mold, the plurality of solenoids are arranged side-by-side, and each of the plurality of pilot diaphragms are in communication with one of the plurality of solenoids. In a third example of the system, optionally including one or both of the first and second examples, the pilot assembly further comprises a plurality of main diaphragms formed as a single injection mold, wherein each of the plurality of solenoid-actuated pilot valve assemblies controls pressure differential across one or more of the plurality of main diaphragms. In a fourth example of the system, optionally including one or more or each of the first through third examples, the plurality of main diaphragms, controlled by the plurality of solenoid-actuated pilot valve assemblies, controls fluid flow between fluid chambers arranged in separate sections by opening and/or closing a plurality of orifices. In a fifth example of the system, optionally including one or more or each of the first through fourth examples, the pilot assembly further comprises an enclosure that includes a plurality of particle filters positioned between the fluid manifold and the plurality of selectively couplable fluid chambers. In a sixth example of the system, optionally including one or more or each of the first through fifth examples, actuation of one of the plurality of solenoid-actuated pilot valve assemblies changes pressure differential across more than one of the plurality of main diaphragms. In a seventh example of the system, optionally including one or more or each of the first through sixth examples, the plurality of ports comprises a plurality of inlet ports and a plurality of outlet ports, the plurality of inlet ports being coupled to the first section of the fluid manifold and the plurality of outlet ports being coupled to the second section of the fluid manifold. In a eighth example of the system, optionally including one or more or each of the first through seventh examples, the system further comprises: an integrated pump and a pump inlet port coupled to the integrated pump. In a ninth example of the system, optionally including one or more or each of the first through eighth examples, each of the plurality of solenoids is electronically coupled to a control board via a pin connector, the control board providing current to energize each of the plurality of solenoids.

The disclosure also provides support for a fluid distribution system for reconfigurable thermal management of a vehicle, comprising: a fluid manifold including a first section and a second section, the first section including a plurality of inlet ports in fluid communication with a plurality of fluid chambers and the second section including a plurality of outlet ports in fluid communication with the plurality of fluid chambers, a pilot assembly including a manifold subassembly, the manifold subassembly including an upper section and a lower section, and a pump in fluid communication with the plurality of fluid chambers, wherein the plurality of outlet ports selectively direct fluid flow to a plurality of components of the vehicle in which the fluid distribution system is housed. In a first example of the system, the plurality of fluid chambers are arranged in the first section of the fluid manifold and the second section of the fluid manifold, fluid chambers of the first section and fluid chambers of the second section being in selective fluid communication via a plurality of orifices when the plurality of orifices are open. In a second example of the system, optionally including the first example, the plurality of orifices are opened and/or closed based on pressure differential across a plurality of main diaphragms. In a third example of the system, optionally including one or both of the first and second examples, pressure differential across the plurality of main diaphragms is controlled by a plurality of solenoid-actuated pilot valve assemblies. In a fourth example of the system, optionally including one or more or each of the first through third examples, the pump includes a pump inlet port in fluid communication with one or more components of the vehicle. In a fifth example of the system, optionally including one or more or each of the first through fourth examples, an involute of the pump is formed with a mold of the first section of the fluid manifold.

The disclosure also provides support for a pilot assembly for a fluid distribution system, comprising: a pilot manifold with a plurality of manifold sections, the pilot manifold coupled to a fluid manifold, a plurality of selectively couplable fluid chambers arranged in sections of the fluid manifold, a plurality of main diaphragms arranged to allow flow between the selectively couplable fluid chambers, and a plurality of solenoid valves in fluid communication with the plurality of main diaphragms, wherein the pilot assembly is integrated into the fluid manifold of the fluid distribution system. In a first example of the system, the plurality of solenoid valves are pilot-operated and configured to be operated to control pressure differential across the plurality of main diaphragms to open and/or close a plurality of orifices in fluid communication with the plurality of main diaphragms. In a second example of the system, optionally including the first example, opening of one of the plurality of orifices selectively couples fluid chambers arranged in separate sections of the fluid manifold. In a third example of the system, optionally including one or both of the first and second examples, the system further comprises: a control board that provides current to energize the plurality of solenoid valves, wherein the control board is electrically coupled to the plurality of solenoid valves and an electrical interface integrated into the fluid manifold.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A fluid distribution system, comprising:
a fluid manifold having a plurality of ports in fluid communication with a plurality of selectively couplable fluid chambers;
a pilot assembly comprising a plurality of solenoid-actuated pilot valve assemblies controlling fluid flow between the plurality of selectively couplable fluid chambers, wherein:
the plurality of selectively couplable fluid chambers are arranged in a first section and a second section of the fluid manifold, the first section and the second section separated by a coupling plane;
fluid chambers in fluid communication are arranged in opposing ends of the coupling plane;
the plurality of solenoid-actuated pilot valve assemblies are housed in a common assembly and mounted directly to the fluid manifold; and
one or more of the plurality of solenoid-actuated pilot valve assemblies controls flow through at least one of the selectively couplable fluid chambers.

2. The fluid distribution system of claim 1, wherein the plurality of solenoid-actuated pilot valve assemblies comprise a plurality of solenoids and a plurality of pilot diaphragms.

3. The fluid distribution system of claim 2, wherein:
the plurality of pilot diaphragms are arranged side-by-side and formed as a single injection mold;
the plurality of solenoids are arranged side-by-side; and
each of the plurality of pilot diaphragms are in communication with one of the plurality of solenoids.

4. The fluid distribution system of claim 1, wherein the pilot assembly further comprises a plurality of main diaphragms formed as a single injection mold, wherein each of the plurality of solenoid-actuated pilot valve assemblies controls pressure differential across one or more of the plurality of main diaphragms.

5. The fluid distribution system of claim 4, wherein the plurality of main diaphragms, controlled by the plurality of solenoid-actuated pilot valve assemblies, controls fluid flow between fluid chambers arranged in separate sections by opening and/or closing a plurality of orifices.

6. The fluid distribution system of claim 1, wherein the pilot assembly further comprises an enclosure that includes a plurality of particle filters positioned between the fluid manifold and the plurality of selectively couplable fluid chambers.

7. The fluid distribution system of claim 4, wherein actuation of one of the plurality of solenoid-actuated pilot valve assemblies changes pressure differential across more than one of the plurality of main diaphragms.

8. The fluid distribution system of claim 1, wherein the plurality of ports comprises a plurality of inlet ports and a plurality of outlet ports, the plurality of inlet ports being coupled to the first section of the fluid manifold and the plurality of outlet ports being coupled to the second section of the fluid manifold.

9. The fluid distribution system of claim 1, further comprising an integrated pump and a pump inlet port coupled to the integrated pump.

10. The fluid distribution system of claim 2, wherein each of the plurality of solenoids is electronically coupled to a control board via a pin connector, the control board providing current to energize each of the plurality of solenoids.

11. A fluid distribution system for reconfigurable thermal management of a vehicle, comprising:
a fluid manifold including a first section and a second section, the first section including a plurality of inlet ports in fluid communication with a plurality of fluid chambers and the second section including a plurality of outlet ports in fluid communication with the plurality of fluid chambers;
a pilot assembly including a manifold subassembly, the manifold subassembly including an upper section and a lower section; and
a pump in fluid communication with the plurality of fluid chambers; wherein the plurality of outlet ports selectively direct fluid flow to a plurality of components of the vehicle in which the fluid distribution system is housed.

12. The fluid distribution system of claim 11, wherein the plurality of fluid chambers are arranged in the first section of the fluid manifold and the second section of the fluid manifold, fluid chambers of the first section and fluid chambers of the second section being in selective fluid communication via a plurality of orifices when the plurality of orifices are open.

13. The fluid distribution system of claim 12, wherein the plurality of orifices are opened and/or closed based on pressure differential across a plurality of main diaphragms.

14. The fluid distribution system of claim 13, wherein pressure differential across the plurality of main diaphragms is controlled by a plurality of solenoid-actuated pilot valve assemblies.

15. The fluid distribution system of claim 11, wherein the pump includes a pump inlet port in fluid communication with one or more components of the vehicle.

16. The fluid distribution system of claim 11, wherein an involute of the pump is formed with a mold of the first section of the fluid manifold.

17. A pilot assembly for a fluid distribution system, comprising:
a pilot manifold with a plurality of manifold sections, the pilot manifold coupled to a fluid manifold;
a plurality of selectively couplable fluid chambers arranged in sections of the fluid manifold;
a plurality of main diaphragms arranged to allow flow between the selectively couplable fluid chambers; and
a plurality of solenoid valves in fluid communication with the plurality of main diaphragms, wherein the pilot assembly is integrated into the fluid manifold of the fluid distribution system.

18. The pilot assembly of claim 17, wherein the plurality of solenoid valves are pilot-operated and configured to be operated to control pressure differential across the plurality of main diaphragms to open and/or close a plurality of orifices in fluid communication with the plurality of main diaphragms.

19. The pilot assembly of claim 18, wherein opening of one of the plurality of orifices selectively couples fluid chambers arranged in separate sections of the fluid manifold.

20. The pilot assembly of claim 17, further comprising a control board that provides current to energize the plurality of solenoid valves, wherein the control board is electrically coupled to the plurality of solenoid valves and an electrical interface integrated into the fluid manifold.
